(19) United States
(12) Patent Application Publication
(10) Pub. No.: US 2015/0213049 A1
(43) Pub. Date: Jul. 30, 2015

(54) ASYNCHRONOUS BACKEND GLOBAL DEDUPLICATION

(71) Applicant: NetApp, Inc., Sunnyvale, CA (US)

(72) Inventors: Steven R. Kleiman, Los Altos, CA (US); Mark Walter Storer, Walnut Creek, CA (US); Minglong Shao, San Jose, CA (US); Sethuraman Subbiah, San Jose, CA (US); Shankar Pasupathy, Milpitas, CA (US)

(21) Appl. No.: 14/168,348

(22) Filed: Jan. 30, 2014

(51) Int. Cl. G06F 17/30

(52) U.S. Cl. CPC G06F 17/30159

(57) ABSTRACT

A method of performing a global deduplication may include: collecting a data chunk to be written to a backing storage of a storage system at a staging area in the storage system; generating a data fingerprint of the data chunk; sending the data fingerprint in batch along with other data fingerprints corresponding to data chunks collected at different times to a metadata server system in the storage system; receiving an indication, at the staging area, of whether the data fingerprint is unique in the storage system from the metadata server system; and discarding the data chunk when committing a data object containing the data chunk to the backing storage, when the indication indicates that the data chunk is not unique.

### TECHNOLOGY FIELD

At least one embodiment of the present disclosure pertains to data storage systems, and more particularly, to performing deduplication across a data storage system.

### BACKGROUND

Scalability is an important requirement in many data storage systems, particularly in network-oriented storage systems, e.g., network attached storage (NAS) systems and storage area network (SAN) systems. Different types of storage systems provide diverse methods of seamless scalability through storage capacity expansion including virtualized volumes of storage across multiple storage servers (e.g., a server cluster containing multiple server nodes.

A process used in many storage systems that can affect scalability is data deduplication. Data deduplication is an important feature for data storage systems, particularly for distributed data storage systems. Data deduplication is a technique to improve data storage utilization by reducing data redundancy. A data deduplication process identifies duplicate data and replaces the duplicate data with references that point to data stored elsewhere in the data storage system. However, existing deduplication technology for storage systems suffer deficiencies in scalability and flexibility of the storage system, including bottlenecking at specific server nodes in the I/O flow of the storage system.

### BRIEF DESCRIPTION OF THE DRAWINGS

FIG. 1 is a control flow diagram illustrating a technique of global deduplication in a storage system, consistent with various embodiments.

FIG. 2 illustrates an example of a data storage system, consistent with various embodiments.

FIG. 3 is a high-level block diagram showing an example of an architecture of a node of the storage system, consistent with various embodiments;

FIG. 4A illustrates a process of performing global deduplication in a storage system with multiple staging areas for incoming writes, consistent with various embodiments;

FIG. 4B illustrates a process of processing read requests in the storage system of FIG. 4A, consistent with various embodiments;

FIG. 5 illustrates a process of determining uniqueness of data chunks in a metadata server of a metadata server system serving a storage system with multiple staging areas, consistent with various embodiments;

FIG. 6 illustrates a system architecture of a host-based cache system implementing global deduplication, consistent with various embodiments;

FIG. 7 illustrates a system architecture of a file backup system, e.g., a cloud backup, enterprise file share system, or a centralized backup system, implementing global deduplication, consistent with various embodiments;

FIG. 8 illustrates a system architecture of a cache appliance system implementing global deduplication, consistent with various embodiments;

FIG. 9 illustrates a system architecture of an expandable volume system implementing global deduplication, consistent with various embodiments; and

FIG. 10 illustrates a system architecture of a distributed object storage system implementing global deduplication, consistent with various embodiments.

The figures depict various embodiments of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

The technology introduced here includes a method of performing asynchronous global deduplication in a variety of storage architectures. Asynchronous deduplication here refers to performing deduplication of data outside of an I/O flow of a storage architecture. For example, the technology includes global deduplication in host-based flash cache, cache appliances, cloud-backup, infinite volumes, centralized backup systems, object-based storage platforms, e.g., StorageGRID™, and enterprise file hosting and synchronization service, e.g., Dropbox™. The disclosed technology performs an asynchronous deduplication across a storage system for backing up data utilizing a global data fingerprint tracking structure (“global fingerprint store”). “Data fingerprint” refers to a value corresponding to a data chunk (e.g., a data block, a fixed sized portion of data comprising multiple data blocks, or a variable sized portion of data comprising multiple data blocks) that uniquely or with substantially high probability to uniquely identify the data chunk. For example, data fingerprint can be a result of running a hashing algorithm on the data chunk. The global fingerprint store is “global” in the sense that it tracks fingerprint updates from every staging area in the storage system. For example, if each server node in a storage system has a staging area, then the global fingerprint store tracks fingerprint updates from every one of the server nodes.

For example, the global data fingerprint tracking structure can be the global data structure disclosed in U.S. patent application Ser. No. 13/479,138 titled “DISTRIBUTED DEDUPLICATION USING GLOBAL CHUNK DATA STRUCTURE AND EPOCHS” filed on May 23, 2012, which is incorporated herein in its entirety. The subject matter incorporated herein is intended to be examples of methods and data structures for implementing global deduplication consistent with various embodiments, and is not intended to redefine or limit elements or processes of the present disclosure.

The asynchronous deduplication can be realized through asynchronous updates of data fingerprints of incoming data from one or more staging areas of the storage system to a metadata server system. A staging area is a storage space for collecting and protecting data chunks to be written to a backing storage of the storage system. The staging area can begin to clear its contents when full by contacting the metadata server system with the data fingerprints of data chunks in the staging area. The metadata server system can then reply with a list of data fingerprints that are unique (i.e., not currently in the storage system). The staging area can then commit the unique data chunks to the backing storage system of the storage system and discard duplicate data chunks (i.e., data chunks corresponding to non-unique fingerprints). The metadata server system can also contain a list of unique data chunks that comprise each stored data object in the storage system.

The backing storage is a persistent portion of the storage system to store data. The backing storage can be a separate set of storage devices from device implementing the staging area, which can also be persistent storage. The backing storage can be distributed within a storage cluster implementing the storage system. The staging areas, the metadata server system, and the backing storage system can be part of the storage system. The staging areas, the metadata server system, and the backing storage system can be implemented on separate hardware devices. Any two or all three of the staging areas, the metadata server system, and the backing storage system can be implemented on or partially or completely share the same hardware device(s). In some embodiments, each node (e.g., virtual or physical server node in a storage system implemented as a storage cluster) includes a staging area.

The metadata server system maintains the global fingerprint store, e.g., a hash table, that tracks data fingerprints (e.g., hash values generated based on data chunks of data objects) corresponding to unique data chunks. The metadata server system can be scalable. The metadata server system can comprise of one or more storage nodes, e.g., storage servers or other storage devices. The multiple metadata servers may be virtual or physical servers. Each of the multiple metadata servers can maintain a version of the global data structure tracking the unique fingerprints. The version may include a partitioned portion of unique data fingerprints in the storage system or all of the known unique data fingerprints in the storage system at a specific time. The multiple metadata servers can update each other in an “epoch-based” methodology. An epoch-based update refers to freezing a consistent view of a storage system at points in time through versions of the global fingerprint store. The global fingerprint store allows a storage system to deduplicate data in an efficient manner. The asynchronous deduplication scales well to an arbitrary number of nodes in a cluster, enables a reduction in amount of data required to be transferred from a staging area to a backing storage system in the storage system for persistent storage, and enables deduplication without delaying the I/O flow of the storage system.

The asynchronous global deduplication technology enables a more efficient accumulation of data. For example, the staging area can accumulate data at high speed, without having to compute and lookup each individual fingerprint in real-time. The fingerprint lookup can be delayed and accomplished in a bulk/batch fashion, which is more efficient and reduces number of messages between the staging area and the metadata server system that keeps track of the fingerprint list.

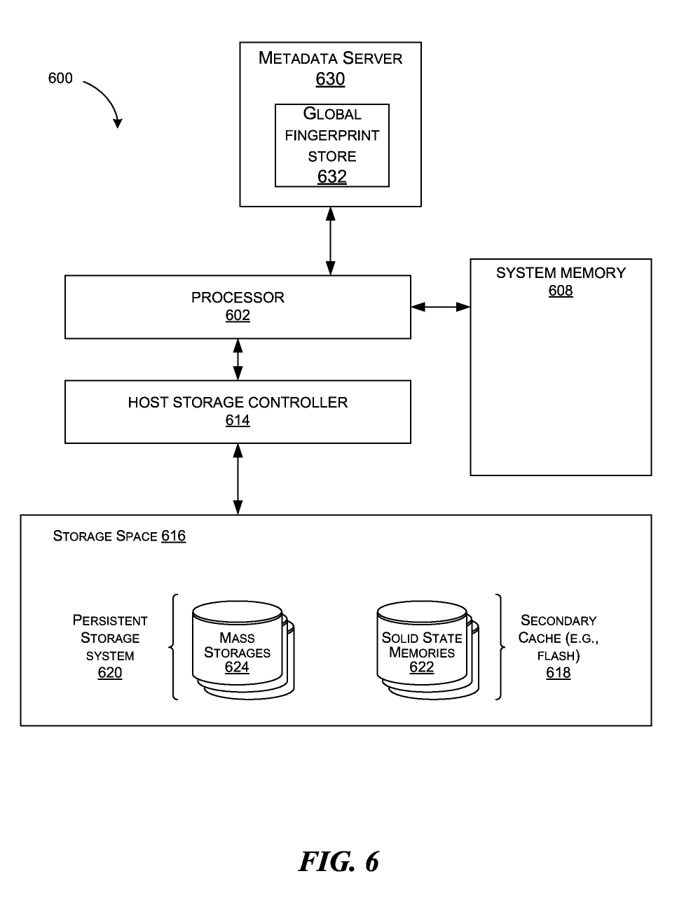

This disclosed technology leverages advantages of a scalable metadata server system to provide the ability to have only a single instance of each data chunk (e.g., data block) that is shared across many storage server nodes (i.e., global dedup) in many different deployment scenarios, exemplified by various system architectures of FIGS. 6-10. The system architectures may be used to optimize traffic between remotely located devices by ensuring that only the data that has not been seen previously is transferred.

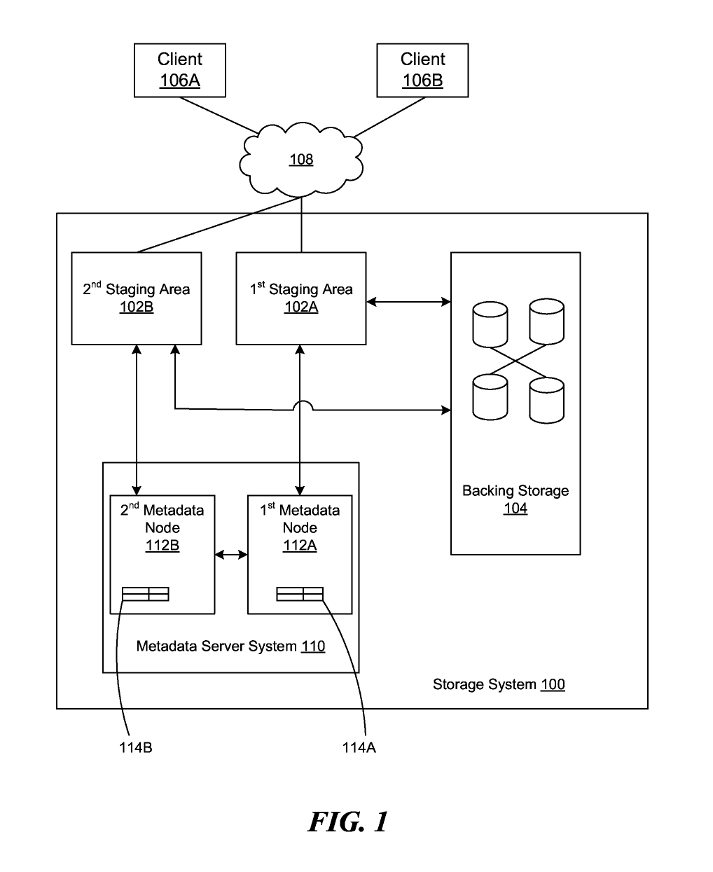

FIG. 1 is a control flow diagram illustrating a technique of global deduplication in a storage system 100, consistent with various embodiments. Global data deduplication is a method of preventing redundant data when backing up data to multiple devices. With global deduplication, when data is prepared to be backed up from a first staging area 102A to a backing storage 104, a global deduplication process operating the first staging area 102 can recognize that the backing storage 104 already has a copy of the data, and does not make an additional copy by sending the data over to the backing storage. Global data deduplication makes the data deduplication process more effective and increases the data deduplication ratio (the ratio of capacity before deduplication to the actual physical capacity stored after deduplication), which helps to reduce the required capacity of storage devices (e.g., disk or tapes systems) used to store backup data. The backing storage 104, for example, can be a storage cluster, a cloud backup system, a centralized backup server system, virtualized storage hosts, virtualized volume distributed across multiple storage hardware or filesystems, or any combination thereof. Under global data deduplication, the storage system 100 can include multiple staging areas, e.g., the first staging area 102A and a second staging area 102B (collectively as “staging areas 102”). The staging areas 102, for example, may include a storage gateway, a cache (e.g., flash cache, peer to peer cache, host-based cache, or a cache appliance), a temporary file folder, a mobile device, a client-side device, or any combination thereof.

The storage system 100 can service one or more clients, e.g., client 106A and client 106B (collectively as the “clients 106”), by storing, retrieving, maintaining, protecting, and managing data for the clients 106. Each of the staging areas 102 can service one or more of the clients 106. The storage system 100 can communicate with the clients 106 through a network channel 108. The network channel 108 can comprise one or more interconnects carrying data in and out of the storage system 100. The network channel 108 can comprise subnetworks. For example, a subnetwork can facilitate communication between the client 106A and the first staging area 102A while a different subnetwork can facilitate communication between the client 106B and the second staging area 102B. The clients 106, for example, can include application servers, application processes running on computing devices, or mobile devices. In some embodiments, the clients 106 can run on the same hardware appliance as the staging areas 102, where, for example, the client 106A can communicate directly with the first staging area 102A via internal network on a computing device, without going through an external network.

A global deduplication process can operate on each of the staging areas 102. The global deduplication process can collect incoming data objects from the clients 106 to be written to the storage system 100 at each of the staging areas 102. The global deduplication process can divide the data objects into data chunks, which are fixed sized or variable sized contiguous portions of the data objects. The global deduplication process can also generate a data fingerprint for each of the data chunks. For example, the data fingerprint may be generated by running a hash algorithm on each of the data chunks. In response to a trigger event, the global deduplication process can send the data fingerprints corresponding to the data chunks to a metadata server system 110. For example, the data fingerprints may be sent over to the metadata server system 110 as a fingerprints message.

The trigger event can be based on a set schedule (i.e., a schedule indicated in the configuration of the global deduplication process). The set schedule may be based on a periodic schedule. The set schedule of each instance of the global deduplication process may be synchronized to each other by synchronizing with a system clock available to each instance operating on each of the staging areas 102. Alternatively, the trigger event may be based on a state of a staging area. For example, the trigger event can occur whenever a staging area is full (i.e., at its maximum capacity) or if the staging area reaches a threshold percentage of its maximum capacity. The trigger event may further be based on an external message, e.g., a message from one of the clients 106.

The metadata server system 110 includes one or more metadata nodes, e.g., a first metadata node 112A and a second metadata node 112B (collectively as metadata nodes 112). In some embodiments, each of the metadata nodes 112 can act on behalf of the metadata server system 110 to reply to a staging area of whether a data fingerprint is unique in the storage system 100. An instance of the global deduplication process may specifically select one of the metadata nodes 112 to send a specific data fingerprint based on a characteristic of the specific data fingerprint, e.g., a characteristic of a hash value representing the specific data fingerprint. An instance of the global deduplication process may also specifically select one of the metadata nodes 112 to send a specific data fingerprint based on a characteristic of the staging area (e.g., each staging area being assigned to a particular metadata node). In some embodiments, one of the metadata nodes 112 may be preselected to route the fingerprints message from the staging areas 102 to the other metadata nodes.

Once a metadata node receives a fingerprints message, the metadata node can compare fingerprints in the fingerprints message against a version of a global fingerprint store available in the metadata node (e.g., a first version 114A of the global fingerprint store and a second version 114B of the global fingerprint store). The comparison can determine whether a particular fingerprint is unique or not in the storage system 100 according to the version of the global fingerprint store available in the metadata node. In some embodiments, the version of the global fingerprint store contains a portion of all unique fingerprints in the storage system 100, e.g., where the portion corresponds to a specific subset of the staging areas 102 or a particular group of the fingerprints according to a characteristic of the fingerprints. In other embodiments, the version of the global fingerprint store contains all unique fingerprints in the storage system 100 at a specific point in time. In some embodiments, unique fingerprints across the entire storage system 100, including the staging areas 102 and the backing storage 104, is tracked by the global fingerprint store. In other embodiments, unique fingerprints across only the backing storage 104 is tracked by the global fingerprint store. Again here, “unique fingerprints” as defined by the metadata node is defined according to the version of the global fingerprint store.

When a particular fingerprint is determined to be unique by a metadata node (i.e., not to exist in the version of the global fingerprint store in the metadata node), then the metadata node can modify and add the particular fingerprint to its version of the global fingerprint store. Aside from updating the version of the global fingerprint store according to the fingerprints messages from the staging areas 102, the version of the global fingerprint store may also be updated periodically from other metadata nodes in the metadata server system 110. For example, the metadata nodes 112 can be scheduled for a rolling update from one metadata node to another. The sequence of which metadata node to update first may be determined based on load-balancing considerations, amount of updates to the current version of the global fingerprint store, or other considerations related to a state of a metadata node or a state of the global fingerprint store. The sequence of which metadata node to update may also be determined arbitrarily. A version indicator (e.g., an epoch indicator) can be stored on the metadata node to facilitate the updating of the global fingerprint store.

The metadata node can generate a response message in response to receiving a fingerprints message from the staging area. When a particular fingerprint is determined to be not unique by the metadata node (i.e., the particular fingerprint exists in the version of the global fingerprint store in the metadata node), the response message may contain an indication that a data chunk corresponding to the particular fingerprint exists in the storage system 100 or in the backing storage 104. In some embodiments, the indication includes a specific storage location in the backing storage 104 where an existing data chunk corresponds to the same particular fingerprint. In other embodiments, the indication includes a hint or suggestion to where an existing data chunk corresponding to the same particular fingerprint can be found in the backing storage 104 or simply that the existing data chunk is in the backing storage 104. The specific storage location or the hint of where the existing data chunk may exist can be used to deduplicate a data chunk on the staging area corresponding to the particular fingerprint. A reference to the storage location can be mapped/linked to any data objects referencing the data chunk. For example, when committing the data chunk on the staging area corresponding to the particular fingerprint to the backing storage 104, instead of transferring the entire data chunk, a link referencing the storage location is transferred to the backing storage 104 instead.

When a particular fingerprint is determined to be unique by the metadata node (i.e., not to exist in the version of the global fingerprint store in the metadata node), the response message may contain an indication that any data chunk on the staging area corresponding to the particular fingerprint is unique, and thus need not to be deduplicated or need only to be deduplicated with each other (i.e., amongst data chunks in the staging area with the same data fingerprint). When committing a data chunk corresponding to the particular fingerprint to the backing storage 104, the staging area may indicate to the backing storage 104 that the data chunk is unique and thus need not to be deduplicated on the backing storage 104.

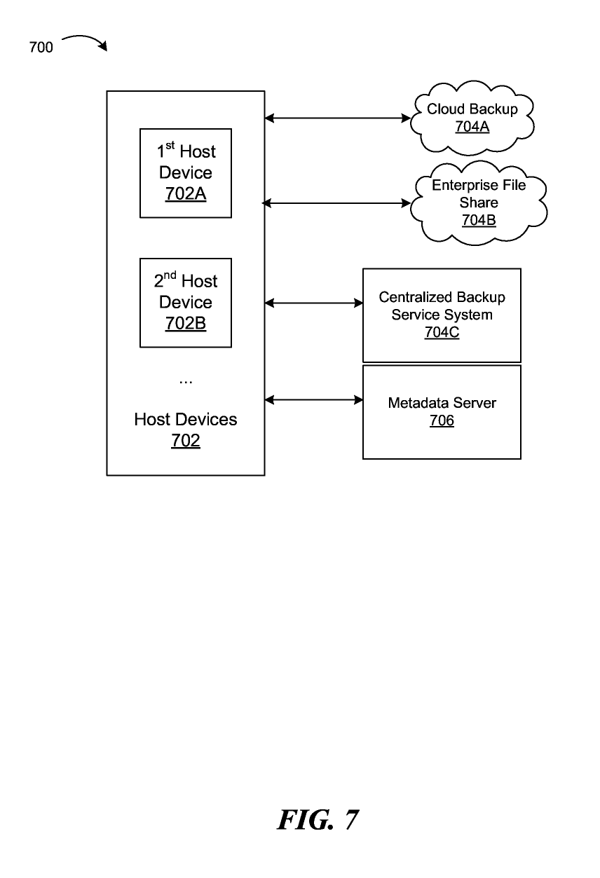

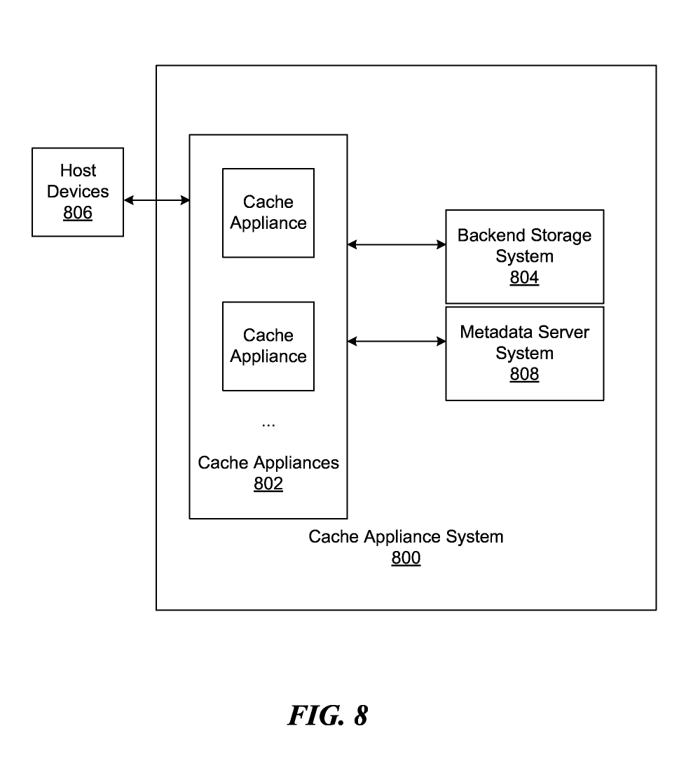

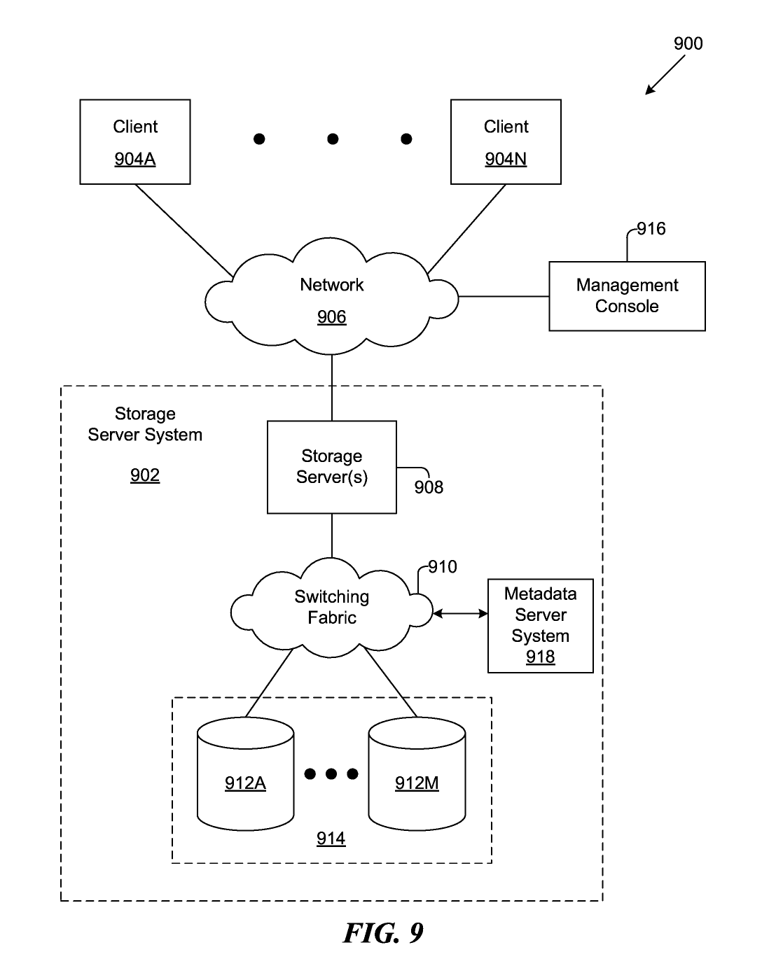

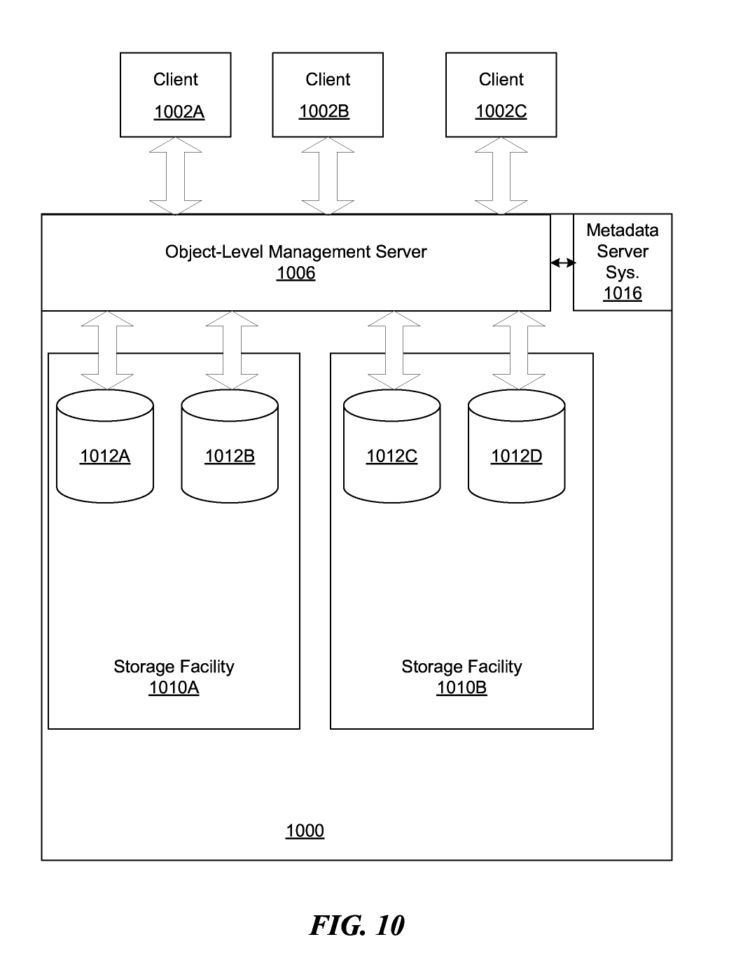

The storage system 100 can be consistent with various storage architectures. For example, the storage system 100 can represent a host-based cache storage system, as further exemplified in FIG. 6. As another example, the storage system 100 can represent a file backup system, including a cloud backup, an enterprise file hosting or synchronization service, or a centralized backup service, as further exemplified in FIG. 7. As yet another example, the storage system 100 can represent a cache appliance system, as further exemplified in FIG. 8. Other examples include the storage system 100 representing an expandable volume system as exemplified in FIG. 9 or an object based storage system as exemplified in FIG. 10.

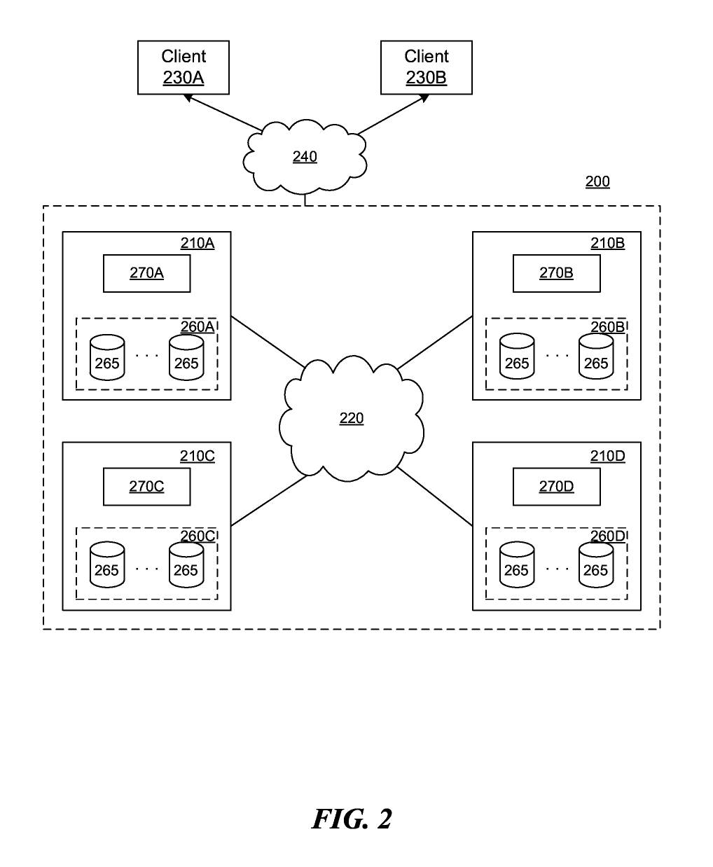

FIG. 2 illustrates an example of a data storage system 200, consistent with various embodiments. The storage system can be a storage cluster in which the technique being introduced here can be implemented. In FIG. 2, the data storage system 200 includes a plurality of data nodes (210A, 210B) and metadata nodes (210C, 210D). The plurality of data nodes (210A, 210B) can be the staging areas 102 of FIG. 1. The plurality of metadata nodes (210C, 210D) can be the metadata nodes 112 of FIG. 1. The data nodes 210A, 210B provide distributed storage of data chunks. The nodes can communicate with each other through an interconnect 220. The interconnect 220 may be, for example, a local area network (LAN), wide area network (WAN), metropolitan area network (MAN), global area network, e.g., the Internet, a Fibre Channel fabric, or any combination of such interconnects. Clients 230A and 230B may communicate with the data storage system 200 by contacting one of the nodes via a network 240, which can be, for example, the Internet, a LAN, or any other type of network or combination of networks. Each of the clients may be, for example, a conventional personal computer (PC), server-class computer, workstation, handheld computing/communication device, or the like.

Each node 210A, 210B, 210C or 210D receives and responds to various read and write requests from clients such 230A or 230B, directed to data stored in or to be stored in persistent storage 260. Each of the nodes 210A, 210B, 210C and 210D contains a persistent storage 260 which includes a number of nonvolatile mass storage devices 265. The nonvolatile mass storage devices 265 can be, for example, conventional magnetic or optical disks or tape drives; alternatively, they can be non-volatile solid-state memory, e.g., flash memory, or any combination of such devices. In some embodiments, the mass storage devices 265 in each node can be organized as a Redundant Array of Inexpensive Disks (RAID), in which the node 210A, 210B, 210C or 210D accesses the persistent storage 260 using a conventional RAID algorithm for redundancy.

Each of the nodes 210A, 210B, 210C or 210D may contain a storage operating system 270 that manages operations of the persistent storage 260. In certain embodiments, the storage operating systems 270 are implemented in the form of software. In other embodiments, however, any one or more of these storage operating systems may be implemented in pure hardware, e.g., specially-designed dedicated circuitry or partially in software and partially as dedicated circuitry.

Each of the data nodes 210A and 210B may be, for example, a storage server which provides file-level data access services to hosts, e.g., commonly done in a NAS environment, or block-level data access services e.g., commonly done in a SAN environment, or it may be capable of providing both file-level and block-level data access services to hosts. Further, although the nodes 210A, 210B, 210C and 210D are illustrated as single units in FIG. 2, each node can have a distributed architecture. For example, a node can be designed as a combination of a network module (e.g., “N-blade”) and disk module (e.g., “D-blade”) (not shown), which may be physically separate from each other and which may communicate with each other over a physical interconnect. Such an architecture allows convenient scaling, e.g., by deploying two or more N-modules and D-modules, all capable of communicating with each other through the interconnect. Further, each node can be a virtualized node. For example, each node can be a virtual machine or a service running on physical hardware.

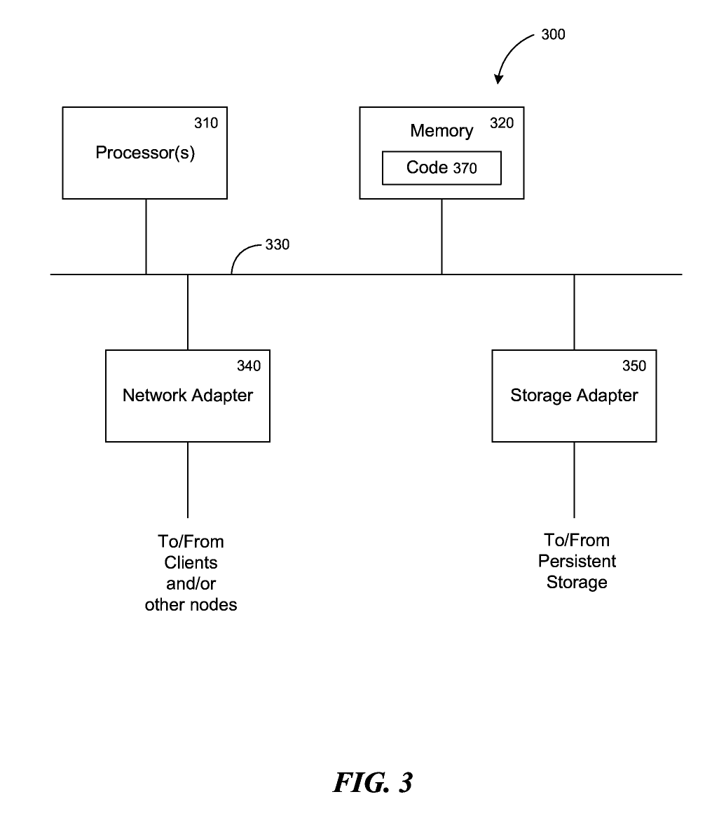

FIG. 3 is a high-level block diagram showing an example of an architecture of a node 300 of a storage system, consistent with various embodiments. The node 300 may represent any of data nodes 210A, 210B or metadata node 210C, 210D. The node 300 includes one or more processors 310 and memory 320 coupled to an interconnect 330. The interconnect 330 shown in FIG. 3 is an abstraction that represents any one or more separate physical buses, point to point connections, or both connected by appropriate bridges, adapters, or controllers. The interconnect 330, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 310 is/are the central processing unit (CPU) of the storage controller 300 and, thus, control the overall operation of the node 300. In certain embodiments, the processor(s) 310 accomplish this by executing software or firmware stored in memory 320. The processor(s) 310 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 320 is or includes the main memory of the node 300. The memory 320 represents any form of random access memory (RAM), read-only memory (ROM), flash memory, or the like, or a combination of such devices. In use, the memory 320 may contain, among other things, code 370 embodying at least a portion of a storage operating system of the node 300. Code 370 may also include a deduplication application.

Also connected to the processor(s) 310 through the interconnect 330 are a network adapter 340 and a storage adapter 350. The network adapter 340 provides the node 300 with the ability to communicate with remote devices, e.g., clients 130A or 130B, over a network and may be, for example, an Ethernet adapter or Fibre Channel adapter. The network adapter 340 may also provide the node 300 with the ability to communicate with other nodes within the data storage cluster. In some embodiments, a node may use more than one network adapter to deal with the communications within and outside of the data storage cluster separately. The storage adapter 350 allows the node 300 to access a persistent storage, e.g., persistent storage 160, and may be, for example, a Fibre Channel adapter or SCSI adapter.

The code 370 stored in memory 320 may be implemented as software and/or firmware to program the processor(s) 310 to carry out actions described below. In certain embodiments, such software or firmware may be initially provided to the node 300 by downloading it from a remote system through the node 300 (e.g., via network adapter 340).

The distributed storage system, also referred to as a data storage cluster, can include a large number of distributed data nodes. For example, the distributed storage system may contain more than 1000 data nodes, although the technique introduced here is also applicable to a cluster with a very small number of nodes. Data is stored across the nodes of the system. The deduplication technology disclosed herein applies to the distributed storage system by gathering deduplication fingerprints from distributed storage nodes periodically, processing the fingerprints to identify duplicate data, and updating a global fingerprint store consistently from a current version to the next version.

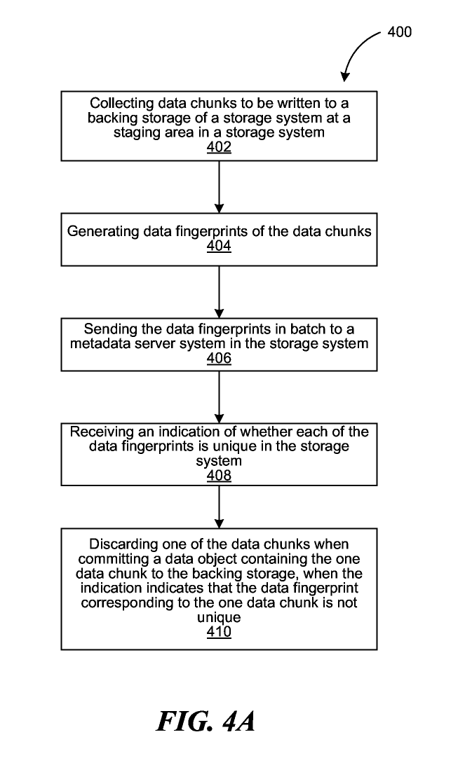

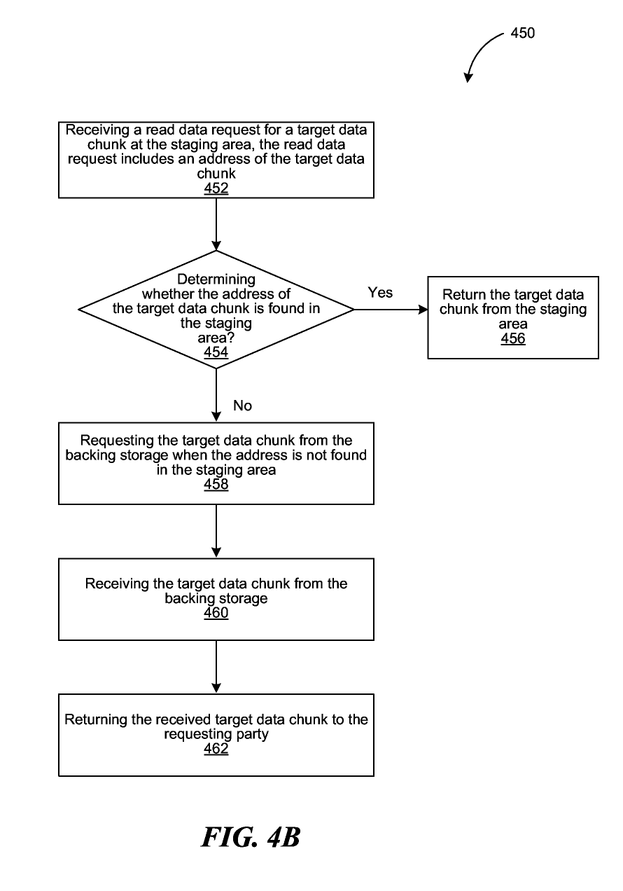

FIG. 4A illustrates a process 400 of performing global deduplication in a storage system with multiple staging areas for incoming writes, consistent with various embodiments. The process 400 includes collecting data chunks to be written to a backing storage of a storage system at a staging area in the storage system in step 402. The staging area can be the first staging area 102A of FIG. 1 or other examples of a staging area in various system architectures described herein. The staging area may be a write-back cache utilizing at least a peer to peer protocol to mirror the data chunks to a peer when the data chunks are collected. The backing storage can be the backing storage 104 of FIG. 1 or other examples of a backing storage in various system architectures described herein. Step 402 may be executed in response to a data write request from a host or a client, e.g., the client 106A of FIG. 1 or the client 230A of FIG. 2. The staging area may be part of the storage system to protect the data chunks before the data chunks are committed to the backing storage. Step 402 may also comprise receiving a write request to store a data object in the backing storage and dividing the data object into data chunks either in a fixed size manner or a variable size manner.

Once a certain amount of data chunks are collected, data fingerprints of the data chunks are generated in step 404. The data fingerprints may be generated at the staging area. For example, the data fingerprints may be generated by a host of the staging area. A data fingerprint requires less storage space than its corresponding data chunk and is for identifying the data chunk. The data fingerprints may be generated by executing a hash function on the data chunks. Each data chunk is represented by a hash value (as its data fingerprint).

Then in step 406, a controller of the staging area (e.g., a storage controller or a processor of a host of the staging area) sends the data fingerprints in batch (e.g., including data fingerprints corresponding to data chunks collected at different times) to a metadata server system in the storage system. The metadata server system can receive batch data fingerprints updates from multiple staging areas. The metadata server system can be the metadata server system 110 of FIG. 1 or other examples of a metadata server system in various system architectures described herein.

Sending of the data fingerprints may be processed independently (i.e., asynchronously) from an I/O path of the staging area. Sending of the data fingerprints may be in response to a trigger event. For example, the data fingerprints may be sent when the staging area reaches its maximum capacity or if the staging area reaches a threshold percentage of its maximum capacity. As another example, the data fingerprints may be sent periodically based on a set schedule. When sending the data fingerprints, the controller of the staging area may determine a metadata node in the metadata server system to send the data fingerprints based on a characteristic of the data fingerprints. Alternatively, where to send the data fingerprints may be determined based on a characteristic of the staging area.

In response to the batch fingerprints update from the staging area, the metadata server system sends and the controller of the staging area receives an indication of whether each of the data fingerprints is unique in the storage system in step 408. When the indication indicates that the data fingerprint of a particular data chunk is not unique and exists in a global fingerprint store of the metadata server system, the metadata server system may also send a storage location identifier of an existing data chunk in the backing storage to the controller of the staging area, where the existing data chunk also corresponds to the data fingerprint of the particular data chunk in the staging area.

When committing a data object containing one of the data chunks in the staging area to the backing storage, the one data chunk is discarded when the indication indicates that the data fingerprint corresponding to the one data chunk is not unique in step 410. The staging area may begin to process the data object to commit the data object to the backing storage when the staging area is full, i.e., at its maximum capacity. The staging area may commit the data object in response to sending the data fingerprints in batch and receiving the indication of whether data fingerprints are unique. When committing the data object to the backing storage, the controller of the staging area may indicate to the backing storage which of the data chunks in the data object have been deduplicated. When committing the data object to the backing storage, the host of the staging area may logically map the storage location of the existing data chunk in place of the one data chunk determined not to be unique prior to or when discarding the one data chunk.

Steps 402 to 410 may correspond to the process 400 of processing of data objects and/or data chunks in write requests to the storage system. FIG. 4B illustrates a process 450 of processing read requests in the storage system of FIG. 4A, consistent with various embodiments. For example, in step 452, the controller of the staging area receives a read data request for a target data chunk at the staging area. The read data request includes an address of the target data chunk. In response, step 454 is called to determine whether the address of the target data chunk is found in the staging area. If the address is found, the controller of the staging area returns, in step 456, the target data chunk from the staging area to the requesting party. If the address is not found, the controller of the staging area requests, in step 458, the target data chunk from the backing storage. Once the controller receives, in step 460, the target data chunk from the backing storage, the controller then returns, in step 462, the received target data chunk to the requesting party.

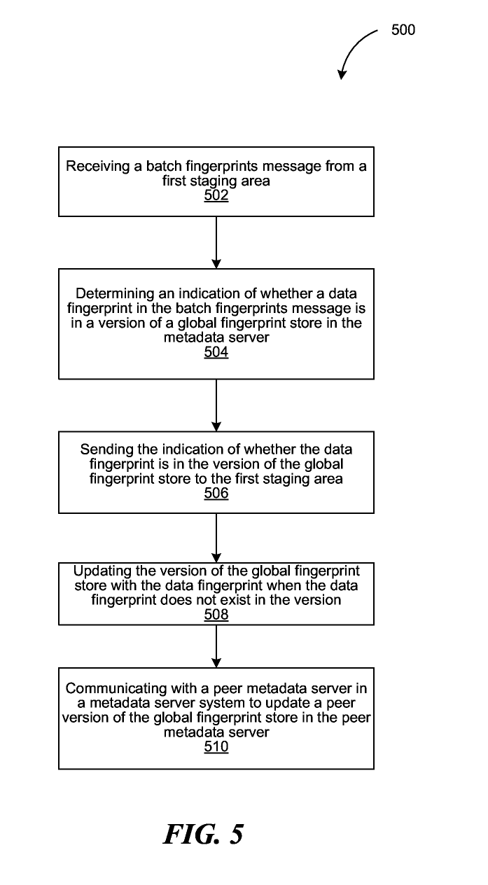

FIG. 5 illustrates a process 500 of determining uniqueness of data chunks in a metadata server of a metadata server system serving a storage system with multiple staging areas, consistent with various embodiments. The metadata server system can be the metadata server system 110 of FIG. 1 or other examples of a metadata server system in various system architectures described herein. The process 500 begins with the metadata server receiving a batch fingerprints message from a first staging area in step 502. Then, the metadata server system determines an indication of whether a data fingerprint in the batch fingerprints message is in a version of a global fingerprint store in the metadata server in step 504. The version of the global fingerprint store can be the versions (114A or 114B) of the global fingerprint store in FIG. 1. The global fingerprint store may be distributed and partitioned amongst logical metadata servers of the metadata server system as different versions of a hash table.

In response to receiving the batch fingerprints message and determining the indication, the metadata server sends the indication of whether the data fingerprint is in the version of the global fingerprint store (i.e., whether the metadata server accords that the data fingerprint is unique) to the first staging area in step 506. As part of step 506, the metadata server may also send a storage location identifier of an existing data chunk in a backing storage, where the existing data chunk corresponds to the same data fingerprint corresponding to the indication.

Also in response to determining the indication (e.g., in parallel to step 506 or immediately before or after step 506), the metadata server updates the version of the global fingerprint store with the data fingerprint when the data fingerprint does not exist in the version in step 508. The metadata server may store a list of unique data chunks in each data object in the storage system that can be requested by any of the staging areas of the storage system. Thus, the updating of the data fingerprint may also include updating data chunks metadata associated with the data fingerprints and corresponding data objects. A benefit of storing and updating the version of the global fingerprint store in the metadata server system is that the global fingerprint store remains relevant even when data corresponding to data fingerprints of the global fingerprint store is move in an arbitrary manner. After the update in step 508, the metadata server communicates with a peer metadata server in the metadata server system to update a peer version of the global fingerprint store in the peer metadata server in step 510.

The disclosed global deduplication technology may be exemplified in the number of backup systems. FIGS. 6-10 are system architectures that exemplify how the disclosed global deduplication technology may be implemented on various systems.

### Host-Based Flash Cache Example

A storage system often includes a network storage controller that is used to store and retrieve data on behalf of one or more hosts on a network. The storage system may also include a cache to facilitate mass amount of data I/O processing. Solid state cache systems and flash-based cache systems enable the size of cache memory that is utilized by a storage controller to grow relatively large, in many cases, into Terabytes. Furthermore, conventional storage systems are often configurable providing for a variety of cache memory sizes. Typically, the larger the cache size, the better the performance of the storage system. However, cache memory is expensive and performance benefits of additional cache memory can decrease considerably as the size of the cache memory increases, e.g., depending on the workload.

Without expensive and time-consuming simulations running on the storage systems, predicted statistic of how cache memories are used and effectiveness of such cache memories are difficult to come by. A host-based cache system is a system architecture for a storage system that enables the hosts themselves to control the mechanisms that place data either in the cache or a backing storage.

For example, a host-based flash cache system may provide a write-back cache (i.e., a cache implementing a write-back policy, where initially, writing is done only to the cache and the write to the backing storage is postponed until the cache blocks containing the data are about to be modified/replaced by new content) capability using peer-to-peer protocols. This makes the host cache a viable staging area (e.g., one of the staging areas 102 of FIG. 1). Once the write-back cache accumulates an adequate number of written data chunks (and optionally mirrors those block to a peer to provide protection), then a controller of the cache can contact a metadata server system to determine unique data chunks and only commit the unique data chunks to the packing storage. This technique not only deduplicates written data from many hosts, the technique also reduces write traffic from each host since the duplicate/non-unique data chunks are not transferred.

Optionally, a special protocol between the host cache and systems that support deduplication, e.g., Fabric-Attached Storage (FAS) made by NetApp, Inc. of Sunnyvale, Calif., can provide benefits to the systems by writing the unique data chunks in the backing storage and only logically mapping previously existing data chunks in new data objects containing data chunks that are not unique. The cache also optimizes transfer of read data, by returning requested data directly from the cache, and only actually requesting the data from a backing storage when the cache determines that the requested data is not present in the cache.

FIG. 6 illustrates a system architecture of a host-based cache system 600 implementing global deduplication, consistent with various embodiments. The host-based cache system 600 may include one or more processors 602 coupled over a suitable connection to a system memory 608, e.g., dynamic random access memory (DRAM). The system memory 608 may act as a primary cache for the host 601. A set of instructions implemented as a caching process may be executed by the processors 602. The processors 602, in one embodiment, may be coupled to a host storage controller 614.

The host storage controller 614 and/or the processor 602 may be coupled to a storage space 616. Storage devices within the storage space 616 may be on the same physical device as the processors 602 or the host storage controller 614 or on a separate device couple to the host storage controller 614 and/or the processor 602 via network. The storage space 616 may include flash-based memory, other solid-state memory, disk-based memory, tape-based memory, other types of memory, or any combination thereof. The storage space 616 may be accessible directly or indirectly to the host (e.g., the processor 602 and/or the host storage controller 614) to direct system input/output to various physical media regions on the storage space 616.

Most frequently used data may be directed and stored on the fastest media portion of the storage space 616, which acts as a cache for the slower storage. For example, the storage space 616 includes a secondary cache system 618 and a persistent storage system 620. The secondary cache system 618 includes one or more solid-state memories 622, e.g., flash memories. The persistent storage system 620 includes one or more mass storages 624, including tape drives and disk drives. In some embodiments, the mass storages 624 may include solid-state drives as well. If one of the storages becomes filled, the caching process executed by the processor 602 can instruct the storage space 616 to move data from one region to another, via internal instructions. The host-based caching process can provide a caching solution superior to other caching solutions that does not have real time host knowledge and the richness of information needed to effectively control the different types (e.g., faster solid state or flash memory and slower disk memory) within the storage space 616.

The host-based caching technique has the ability to directly control the content of cache (e.g., primary or secondary). By providing information about file types and process priority, the host (e.g., the processor 602 or the storage controller 614) can make decisions based on which logical addresses are touched. This more informed decision can lead to increased performance in some embodiments. Allowing the host to control the mechanisms that place data either in the faster solid state media area or the magnetic slower media area of the storage space may lead to better performance and lower power consumption in some cases. This is because the host may be aware of the additional information associated with inputs/outputs destined for the device and can make more intelligent caching decisions as a result. Thus, the host can control the placement of incoming input and output data within the storage.

In this system architecture, either the system memory 608 or the secondary cache system 618 can be the staging area, e.g., one of the staging areas 102, in accordance with the disclosed global deduplication technology. The persistent storage system 620 can be the backing storage, e.g., the backing storage 104. When the processor 602 issues a write request to write a data object into the persistent storage system 620, the processor 602 can first store the data object in the system memory 608 or the secondary cache system 618, acting as a staging area. For example, when the system memory 608 serves as the staging area, contents of the system memory 608 can be mirrored into the secondary cache system 618 for protection as well. The system memory 608 can also be protected by error correcting code or erasure correcting code.

When the staging area is full, the processor 602 can contact a metadata server 630 (e.g., the metadata node 112A or the metadata node 112B) that maintains a global fingerprint store 632 by sending data fingerprints of data chunks in the data object. Generation of the data fingerprints may occur as a continuous process, in response to the write request, or in response to the staging area being full. The metadata server 630 may be implemented as an external system to the host (as shown) that communicates via a network. Alternatively, the metadata server 630 may be implemented as a service in the host-based cache system 600 (not shown) with the global fingerprint store 632 store in the system memory 608 or the secondary cache system 618. The global deduplication process methods be carry out in accordance with FIG. 4A, FIG. 4B, and FIG. 5.

### File Backup System Example

FIG. 7 illustrates a system architecture of a file backup system 700, e.g., a cloud backup, enterprise file share system, or a centralized backup system, implementing global deduplication, consistent with various embodiments. The file backup system 700 includes multiple host devices 702 including, for example, a first host device 702A and a second host device 702B. Each of the host devices 702 determines what data objects (e.g., files or volumes) need to be backed up and send the data objects to a backup system.

The backup system may be a cloud-based backup, which is a feature that allows a storage device to send backup data directly to a cloud provider 704A. When a set of data chunks in the data objects to be backed-up is determined, the host computer computes data fingerprints of the data chunks and queries a metadata server 706 (e.g., the metadata node 112A or the metadata node 112B of FIG. 1) of a metadata server system for the list of data chunks that are unique amongst all data chunks stored in the cloud provider 704 by this or other devices. Thereafter, only the unique data chunks are transferred to the cloud provider 704A. In this case, the host computer acts as a staging area (e.g., one of the staging areas 102 of FIG. 1) in the cloud provider 704A acts as a backing storage (e.g., the backing storage 104 of FIG. 1).

The backup system may be an enterprise file share system 704B (e.g., Dropbox(™)) for synchronizing and hosting files work similar to the cloud provider 704A. The enterprise file share system 704B may, for example, include a cloud storage. For example, the first host device 702A may be coupled to the enterprise file share system 704B through a file management application installed on the first host device 702A that enables a user to share and store a data object in the enterprise file share system 704B while the same data object is simultaneously accessed from multiple other host devices 702 (i.e., devices with the file management application installed).

The file management application usually includes a file sharing folder where a new data object can be added. The file sharing folder can serve as a local cache and therefore can be a staging area, e.g., one of the staging areas 102. Before syncing the new data object to the enterprise file share system 704B, the first host device 702A can communicate with the metadata server 706 to identify unique data chunks that should be sent to the enterprise file share system 704B.

The backup system may be a centralized backup service system 704C. For example, in large enterprises, it is common for laptops and desktops to run a backup application that periodically backs up users' home directories on the laptops or desktops to a central backup server, e.g., the centralized backup service system 704C. Frequently, up to 60% of home directory data can usually be deduplicated. The backup application can communicate with the metadata server 706 to identify unique data chunks and only send those to the centralized backup service system 704C.

### Cache Appliance System Example

FIG. 8 illustrates a system architecture of a cache appliance system 800 implementing global deduplication, consistent with various embodiments. The cache appliance system 800 includes one or more cache appliances 802, which are separate physical servers or virtualized servers implemented in one or more physical servers. Each of the cache appliances 802 caches data to offload I/O workload (read and write requests) to a backend storage system 804. The backend storage system 804, for example, may be a cloud storage service including the Amazon S3™ cloud service or a centralized backup service. The I/O workload can come from one or more host devices 806, e.g., a client computer/server.

Accordingly, when implementing the disclosed global deduplication technique to the cache appliance system 800, the cache appliances 802 may serve as staging areas, e.g., the staging areas 102 of FIG. 1. The cache appliances 802 may each communicate with a metadata server system 808. Before committing any new data objects to the backend storage system 804, a cache appliance can send data fingerprints of data chunks in the new data objects to the metadata server system 808 to identify unique data chunks that are to be committed to the backend storage system 804.

### Expandable Volume System Example

FIG. 9 illustrates a system architecture of an expandable volume system 900 implementing global deduplication, consistent with various embodiments. The expandable volume system 900 can implement an “infinite volume” that allows data objects to be distributed (e.g., evenly or otherwise) across several or all nodes in a clustered storage system 902. Data written to infinite volumes can be staged in specific storage servers (usually referred to as “N-module” nodes) for managing client requests before being committed to persistent storage managed by storage management servers (usually refers to as “D-module” nodes). Storage servers in the storage server system 902 can switch between being a client management server and a storage management server.

An expandable storage volume is a scalable storage volume including multiple flexible volumes. A “namespace” as discussed herein is a logical grouping of unique identifiers for a set of logical containers of data, e.g., volumes. A flexible volume is a volume whose boundaries are flexibly associated with the underlying physical storage (e.g., aggregate). The namespace constituent volume stores the metadata (e.g., inode files) for the data objects in the expandable storage volume. Various metadata are collected into this single namespace constituent volume.

Multiple client computing devices or systems 904A-904N may be connected to the storage server system 902 by a network 906 connecting the client systems 904A-904N and the storage server system 902. As illustrated in FIG. 9, the storage server system 902 includes at least one storage server 908, a switching fabric 910, and a number of mass storage devices 912A-912M within a mass storage subsystem 914, e.g., conventional magnetic disks, optical disks such as CD-ROM or DVD based storage, magneto-optical (MO) storage, flash memory storage device or any other type of non-volatile storage devices suitable for storing structured or unstructured data. The examples disclosed herein may reference a storage device as a “disk” but the adaptive embodiments disclosed herein are not limited to disks or any particular type of storage media/device, in the mass storage subsystem 914. The client systems 904A-904N may access the storage server 908 via network 906, which can be a packet-switched network, for example, a local area network (LAN), wide area network (WAN) or any other type of network.

The storage server 908 may be connected to the storage devices 912A-912M via the switching fabric 910, which can be a fiber distributed data interface (FDDI) network, for example. It is noted that, within the network data storage environment, any other suitable numbers of storage servers and/or mass storage devices, and/or any other suitable network technologies, may be employed. While the embodiment illustrated in FIG. 9 suggests, a fully connected switching fabric 910 where storage servers can access all storage devices, it is understood that such a connected topology is not required. In various embodiments, the storage devices can be directly connected to the storage servers such that two storage servers cannot both access a particular storage device concurrently.

The storage server 908 can make some or all of the storage space on the storage devices 912A-912M available to the client systems 904A-904N in a conventional manner. For example, a storage device (one of 912A-912M) can be implemented as an individual disk, multiple disks (e.g., a RAID group) or any other suitable mass storage device(s). The storage server 908 can communicate with the client systems 904A-904N according to well-known protocols, e.g., the Network File System (NFS) protocol or the Common Internet File System (CIFS) protocol, to make data stored at storage devices 912A-912M available to users and/or application programs.

The storage server 908 can present or export data stored at storage device 912A-912M as volumes (also referred to herein as storage volumes) to one or more of the client systems 904A-904N. One or more volumes can be managed as a single file system. In various embodiments, a “file system” does not have to include or be based on “files” per se as its units of data storage. Various functions and configuration settings of the storage server 908 and the mass storage subsystem 914 can be controlled from a management console 916 coupled to the network 906. The clustered storage server system 902 can be organized into any suitable number of virtual servers (also referred to as “vservers”), in which one or more these vservers represent a single storage system namespace with separate network access. In various embodiments, each of these vserver has a user domain and a security domain that are separate from the user and security domains of other vservers.

According to the system architecture of the cluster storage server system 902, the storage server 908 can be implemented as a staging area for global deduplication, e.g., one of the staging areas 102 of FIG. 1. For example, the storage server 908 can stage a client write request to write a data object to the storage device 912A, to its cache memory, e.g., a solid state drive. The storage server 908 can contact a metadata server system 918 to determine whether or not data chunks in the data object are unique to the mass storage subsystem 914. In various embodiments, the metadata server system 918 may be connected to the switching fabric 910. In other embodiments, the metadata server system 918 may be implemented outside of the storage server system 902. If the data chunks are unique, then the storage server 908 can commit the data chunks to the mass storage subsystem 914. If the data chunks are not unique, the storage server 908 can discard the data chunks or replaced the data chunks with logical mapping to a storage location of an existing data chunk in the mass storage subsystem 914.

### Distributed Object Storage System Example

FIG. 10 illustrates a system architecture of a distributed object storage system 1000 implementing global deduplication, consistent with various embodiments. The distributed object storage system 1000 may be implemented to be location transparent, that is, locations of storage devices and stored data objects are unknown to clients (e.g., client 1002A, 1002B, and 1002C collectively as “clients 1002”) 1002 of the distributed object storage system 1000. The clients 1002 may communicate directly with an object level management server 1006 of the distributed object storage system 1000, which provides a global data object namespace, object level data management, and object level metadata tagging or query. The object level management server 1006 may be amongst a cluster of object level management servers.

The clients 1002 can communicate via a number of file access protocols 1008 with the object level management server 1006. For example, the file access protocols 1008 may include Common Internet File System (CIFS), Network File System (NFS), and Hyper Text Transfer Protocol (HTTP). The object level management server 1006 can stage I/O workload from the clients 1002 for one or more storage facilities (e.g., storage facility 1010A or storage facility 1010B, collectively as “storage facilities 1010”). The storage facility 1010A, for example, may be a main facility for the distributed object storage system 1000. The storage facility 1010B, for example, may be a disaster recovery facility for the distributed object storage system 1000. Each of the storage facilities 1010 may include one or more storage devices (e.g., storage devices 1012A, 1012B, 1012C, and 1012D, collectively as “storage devices 1012”). The storage devices 1012 may be accessible in the storage facilities 1010 via Serial Advanced Technology Attachment (SATA), Storage Area Network (SAN), Small Computer System Interface (SCSI), or other protocols and connections.

In the system architecture of the distributed object storage system 1000, the object level management server 1006 can be implemented as a staging area for global deduplication, e.g., one of the staging areas 102 of FIG. 1. For example, the object level management server 1006 can stage a client write request to write a data object to the storage devices 1012, to its cache memory, e.g., a solid state drive. The object level management server 1006 can contact a metadata server system 1014 to determine whether or not data chunks in the data object are unique to the storage devices 1012. In various embodiments, the metadata server system 1014 part of the distributed object storage system 1000. In other embodiments, the metadata server system 1016 may be implemented outside of the distributed object storage system 1000. If the data chunks are unique, then the object level management server 1006 can commit the data chunks to one or more of the storage devices 1012. If the data chunks are not unique, the object level management server 1006 can discard the data chunks or replaced the data chunks with logical mapping to a storage location of an existing data chunk in the storage devices 1012.

What is claimed is:

1. A method comprising:
collecting a data chunk to be written to a backing storage of a storage system at a staging area in the storage system, wherein the staging area is part of the storage system to protect the data chunk before the data chunk is committed to the backing storage;
generating a data fingerprint of the data chunk, wherein the data fingerprint requires less storage space than the data chunk and is for identifying the data chunk;
sending the data fingerprint in batch along with other data fingerprints corresponding to other data chunks collected at different times to a metadata server system in the storage system;
receiving an indication, at the staging area, of whether the data fingerprint is unique in the storage system from the metadata server system; and
discarding the data chunk when committing a data object containing the data chunk to the backing storage, when the indication indicates that the data chunk is not unique.

2. The method of claim 1, wherein said collecting the data chunk comprises:
receiving a write request to store the data object; and
dividing the data object into data chunks including the data chunk in a fixed sized manner.

3. The method of claim 1, wherein said collecting the data chunk comprises:
receiving a write request to store the data object; and
dividing the data object into data chunks including the data chunk in a variable sized manner.

4. The method of claim 1, wherein said generating the data fingerprint includes executing a hash function on the data chunk to generate a hash value representing the data fingerprint.

5. The method of claim 1, wherein said sending the data fingerprint in batch is processed independent of an I/O path of the staging area.

6. The method of claim 1, wherein said sending the data fingerprint in batch includes determining a metadata node in the metadata server system to send the data fingerprint based on an identifying characteristic of the staging area.

7. The method of claim 1, wherein said sending the data fingerprint in batch includes determining a metadata node in the metadata server system to send the data fingerprint based on a characteristic of the data fingerprint.

8. The method of claim 1, wherein said committing the data object includes indicating to the backing storage that the data chunk in the data object has been deduplicated.

9. The method of claim 1, wherein said sending of the data fingerprint occurs when the staging area reaches a threshold percentage of its maximum capacity.

10. The method of claim 1, wherein said sending of the data fingerprint occurs periodically based on a set schedule.

11. The method of claim 1, wherein said receiving the indication includes receiving a storage location in the backing storage that contains an existing data chunk corresponding to the data fingerprint.

12. The method of claim 11, wherein committing the data object includes logically mapping the storage location of the existing data chunk in place of the data chunk prior to or when discarding the data chunk.

13. The method of claim 1, wherein the staging area is a write-back cache utilizing at least a peer-to-peer protocol to mirror the data chunk to a peer when the data chunk is collected.

14. The method of claim 1, wherein the staging area includes an error or erasure correcting code to protect the data in the staging area.

15. The method of claim 1, further comprising:
receiving a read data request for a target data chunk at the staging area;
determining whether the target data chunk is stored in the staging area; and
requesting the target data chunk from the backing storage only when the target data chunk is determined not to be in the staging area.

16. A method comprising:
receiving, at a metadata server in a metadata server system serving multiple staging areas, a batch fingerprints message from a first staging area of a storage system;
determining an indication of whether a data fingerprint in the batch fingerprints message is in a version of a global fingerprint store in the metadata server;
sending the indication to the first staging area in response to receiving the batch fingerprints message;
updating the version of the global fingerprint store with the data fingerprint when the data fingerprint is determined not to exist in the global fingerprint store; and
communicating with a peer metadata server in the metadata server system to update a peer version of the global fingerprint store in the peer metadata server.

17. The method of claim 16, wherein the global fingerprint store is distributed and partitioned amongst logical metadata servers of the metadata server system as different versions of a hash table.

18. The method of claim 16, wherein said sending the indication includes sending a storage location identifier of an existing data chunk in a backing storage of the storage system, the existing data chunk corresponding to the same data fingerprint corresponding to the indication.

19. The method of claim 16, further comprising storing a list of unique data chunks in each data object in the storage system that can be requested by the first staging area.

20. A server in a storage system comprising:
a network interface;
a memory serving as a staging area of the storage system to store a data chunk to be asynchronously written to a backing storage of the storage system corresponding to a write request; and
one or more processing devices configured to:
generate a data fingerprint corresponding to the data chunk;
send the data fingerprint to a metadata server through the network interface;
receive an indication, at the staging area, of whether the data fingerprint is unique in the storage system from the metadata server through the network interface;
commit the data chunk in the staging area to the backing storage when the indication indicates that the data fingerprint corresponding to the data chunk is unique; and
discard the data chunk in the staging area when the indication indicates that the data fingerprint corresponding to the data chunk is not unique.

21. The server of claim 20, wherein the server is a host device that generates the write request and wherein the memory is a flash-based cache implementing a write-back policy.

22. The server of claim 20, wherein the one or more processing devices are configured to minor content of the memory to a peer cache.

23. The server of claim 20, wherein the one or more processing devices are configured to maintain an error or erasure correcting code of the staging area to protect the data integrity of the staging area.

24. The host server of claim 20, wherein the network interface is configured to receive the write request from an external client; wherein the server is a cache appliance server serving an external backend storage system providing the backing storage.

25. The host server of claim 20, wherein the network interface is configured to transmit the data chunk to the backing storage when the indication indicates that the data fingerprint corresponding to the data chunk is unique; wherein the backing storage is a cloud backup system, an enterprise file share system, or a centralized backup service system.

26. The host server of claim 20, wherein the network interface is configured to transmit the data chunk to the backing storage through a switching fabric providing the backing storage, when the indication indicates that the data fingerprint corresponding to the data chunk is unique.

27. The host server of claim 20, wherein the network interface is configured to receive the write request addressing a global object namespace and to transmit the data chunk to the backing storage at a storage facility location transparent to a client issuing the write request.
